(19) United States
(12) Patent Application Publication
(10) Pub. No.: US 2005/0232447 A1
(43) Pub. Date: Oct. 20, 2005

(54) Microphone

(75) Inventors: Tsurugi Shinozuka, Machida-shi (JP); Hirokazu Sasaki, Machida-shi (JP); Hiroshi Akino, Machida-shi (JP)

Correspondence Address: HAUPTMAN KANESAKA BERNER PATENT AGENTS, SUITE 300, 1700 DIAGONAL RD, ALEXANDRIA, VA, 22314-2848, US

(73) Assignee: KABUSHIKI KAISHA AUDIO-TECHNICA, Machida-shi (JP)

(21) Appl. No.: 11/101,475

(22) Filed: Apr. 8, 2005

(30) Foreign Application Priority Data
Apr. 16, 2004 (JP) 2004-121491

(51) Int. Cl. H04R 3/00; H04R 1/02

(52) U.S. Cl. 381/122; 381/91; 381/172

(57) ABSTRACT

A microphone uses an infrared light emitting element and an infrared light receiving element as a proximity sensor. The microphone can avoid the adverse effect of disturbing light without the need for a special optical filter to enable a person (speaker) to be reliably sensed. The microphone includes a microphone unit which converts a sound wave into an electric signal to output the signal from a microphone output section 151, and a proximity sensor. An output signal from the proximity sensor controllably turns on and off the microphone output section 151. The proximity sensor includes an infrared light receiving element 131 tuned only to a particular frequency to output a light reception signal and infrared light emitting elements 121 and 122 which emit infrared rays at the frequency to which the infrared light receiving element is tuned.

### FIELD OF THE INVENTION

The present invention relates to a microphone, and more specifically, to a microphone comprising a function for turning on and off a microphone output using a proximity sensor.

### BACKGROUND ART

Some microphones incorporate a proximity sensor. These microphones use the proximity sensor to sense whether or not there is a person in proximity to the microphone. When the sensor senses a person, it turns on the microphone output. When the sensor does not sense any person, it turns off the microphone output.

For example, such a microphone is used in a church having no microphone operator. That is, in such a church a goose neck microphone is set on a platform. If a clergyman is on the platform to preach, the proximity sensor provides a person sense signal to turn the microphone output on. However, when the clergyman is away from the platform in order to allow a choir to sing, the sensor turns off the microphone output so as not to pick up songs of the choir.

Most goose neck microphones are capacitor microphones generally using a phantom power source. The phantom power source does not have an excellent current supply capability, so that the proximity sensor needs to consume reduced power.

Thus, according to the invention described in Patent Document 1 (Japanese Patent Application Publication No. 2004-72559), the proximity sensor comprises a pyroelectric infrared sensor utilizing the pyroelectric characteristic of a pyroelectric substance. Further, according to the invention described in Patent Document 2 (U.S. Pat. No. 5,818,949), the proximity sensor comprises a combination of an infrared light emitting element (for example, an infrared light emitting diode) and an infrared light receiving element (for example, a photodiode). Besides these, an ultrasonic sensor is also known as a proximity sensor.

The pyroelectric infrared sensor has the advantage of consuming only a small amount of power because it need not emit infrared rays. However, when a person (speaker) is stationary, the sensor does not sense the person. Accordingly, the microphone output may be discontinued abruptly. The pyroelectric infrared sensor is not preferable as a proximity sensor.

In connection with the combination of an infrared light emitting element and an infrared light receiving element, direct or alternating current lighting is used to allow the infrared light emitting element (infrared light emitting diode) to emit light. The alternating current lighting provides more intense infrared rays by suppressing heat generated by the light emitting diode.

However, if external light such as sunlight enters the room or there is, for example, a plasma display nearby, which may generate harmonics of infrared rays, this may cause the elements to malfunction. Accordingly, the infrared light receiving element must be provided with a special optical filter. This kind of optical filter is relatively expensive. The ultrasonic sensor consumes a large amount of power and provides sound waves that may be diffracted by surrounding objects. Therefore, the ultrasonic sensor is not reliable in sensing and is not applicable to microphones.

### SUMMARY OF THE INVENTION

It is thus an object of the present invention to provide a microphone which uses an infrared light emitting element and an infrared light receiving element as a proximity sensor and which can reliably sense a person (speaker) by avoiding the adverse effect of disturbing light without the need for a special optical filter.

To accomplish this object, the present invention provides a microphone comprising a microphone unit which converts a sound wave into an electric signal to output the signal from a microphone output section, and a proximity sensor, an output signal from the proximity sensor controllably turning on and off the microphone output section, the microphone being characterized in that the proximity sensor comprises an infrared light receiving element tuned only to a particular frequency to output a light reception signal and an infrared light emitting element which emits infrared rays at the frequency to which the infrared light receiving element is tuned.

The microphone according to the present invention is preferably installed as a goose neck type, on a table such as a platform. In this case, in order to enlarge the sensing area of the sensor, the microphone preferably comprises at least two of the infrared light receiving elements. The infrared light emitting elements are preferably arranged so that their optical axes are inclined at an angle equal to or smaller than 45° with a center line which faces the front of the speaker.

Further, to enable a sensing capability to be varied in accordance with the situation of an area in which the microphone is installed (for example, the size of the area), the microphone preferably comprises driving current adjusting means for adjusting a driving current supplied to the infrared light emitting element.

According to the present invention, the infrared light receiving element has a particular tuning frequency. The infrared light emitting element radiates infrared rays at the tuning frequency. Accordingly, the infrared light receiving element outputs a light reception signal (person sensing signal) only if light radiated by the infrared light emitting element and reflected by a person (speaker) is incident on the infrared light receiving element. This serves to provide a microphone having a proximity sensor that is inexpensive because it eliminates the need for a special, expensive optical filter and that does not malfunction even with disturbing light.

### BRIEF DESCRIPTION OF THE DRAWINGS

FIG. 1 is a front view showing the appearance of a goose neck microphone to which the present invention has been applied;

FIG. 2 is a front view showing a base housing of the microphone;

FIG. 3 is a simplified sectional view of the internal structure of the base housing, the view being taken along line III-III in FIG. 2;

FIG. 4 is a graph showing an example of the characteristics of a tuning infrared light receiving element used in the present invention;

FIG. 5 is a schematic diagram showing how preferred infrared light emitting diodes according to the present invention are arranged; and

FIG. 6 is a schematic diagram showing the configuration of circuits of an infrared transmitting section and an infrared receiving section according to the present invention.

### DETAILED DESCRIPTION

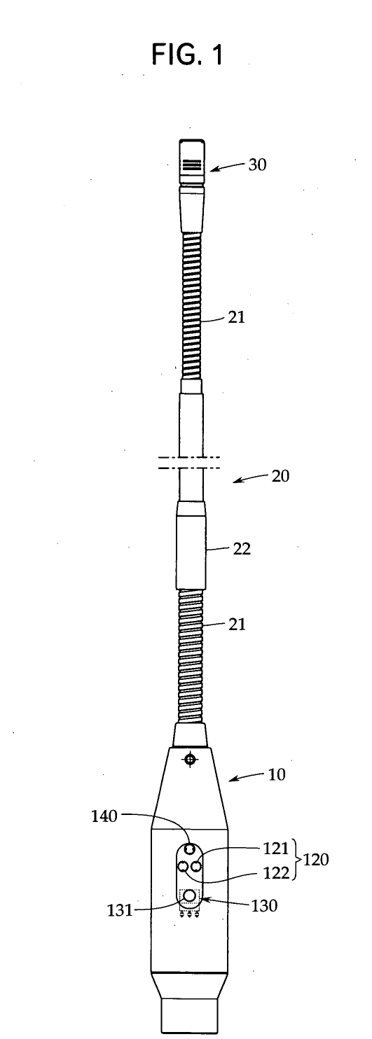

An embodiment of the present invention will be described with reference to FIGS. 1 to 6. However, the present invention is not limited to this.

FIG. 1 shows the appearance of a microphone according to a preferred aspect of the present invention; the microphone is of a goose neck type. The microphone is assumed to be installed on a base such as a table which is not shown in the drawings. Accordingly, the microphone comprises a cylindrical base housing 10 connected to a predetermined fixture provided on the base. The base housing 10 needs to shield incorporated parts from external electromagnetic waves. Thus, the base housing 10 is preferably made of a metal material such as brass.

In this example, a lower end of a flexible support shaft 20 is fixed to an upper end of the base housing 10; the support shaft 20 includes a flexible shaft 21 and a nested telescopic pipe 22. The flexible shaft 21 and the nested telescopic pipe 22 are made of metal. The support shaft 20 is electrically connected to the base housing 10.

A microphone unit 30 is attached to an upper end of the support shaft 20. The microphone unit 30 is roughly classified into a dynamic type and a capacitor type. A goose neck microphone is normally of the capacitor type. The goose neck microphone often uses a phantom power source.

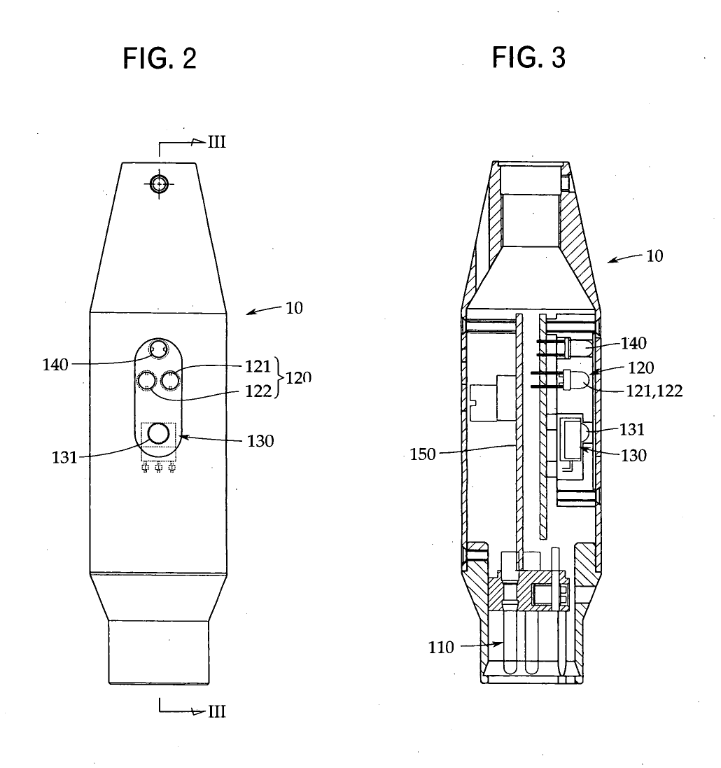

Reference is made to the front view in FIG. 2 and FIG. 3 that is a sectional view taken along line III-III in FIG. 2. The base housing 10 comprises an output connector 110 provided at its lower end and to which a cable from the phantom power source is connected. The output connector 110 is preferably a three-pin connector defined in EIAJ RC-5236 “Latch Lock Round Connector for Acoustic Equipment”.

The base housing 10 has an infrared transmitting section 120 and an infrared light receiving section 130 both provided on its front surface and constituting a proximity sensor. The base housing 10 is also provided with an operation display lamp 140. The operation display lamp 140 may be for example, a red or green light emitting diode that is lighted when a power switch (not shown) is on.

In this example, the infrared transmitting section 120 includes two infrared light emitting diodes 121 and 122. In this case, as shown in FIG. 5, the optical axes 121a and 122a of infrared light emitting diodes 121 and 122 are preferably inclined at an angle equal to or smaller than 45° (in particular, equal to or smaller than 30°) with a center line X that faces the speaker, in order to enlarge the sensing area of the sensor. The number of infrared light emitting diodes may be one or three or more.

According to the present invention, the infrared light receiving section 130 comprises a tuning infrared light receiving element (for example, a photodiode) 131 which is tuned to a particular frequency of infrared rays incident on the infrared light receiving section 130 and outputs a light reception signal. An infrared light receiving element of this kind is for example, Optical Remote-Controlled Light Receiving Module PIC-3704TM2/3724TM2 commercially available from KODENSHI CORP.

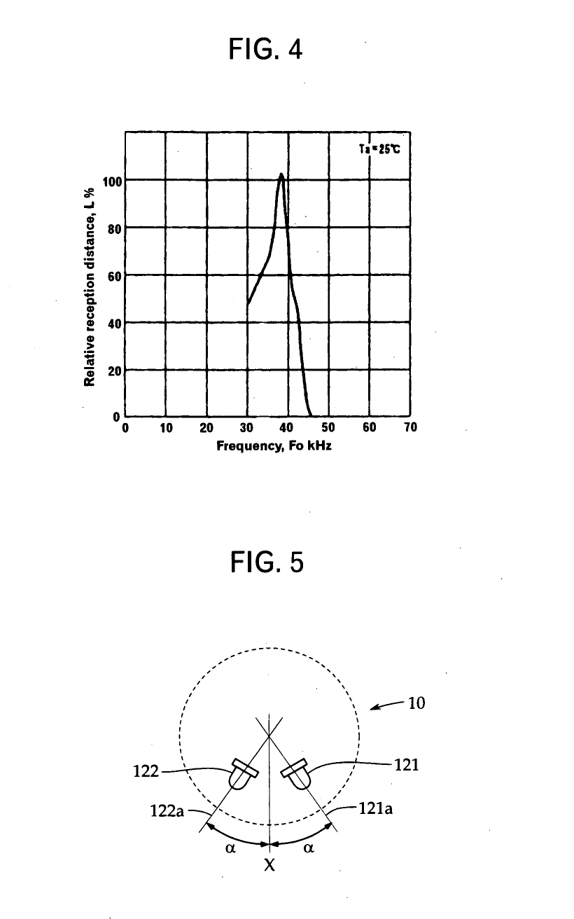

This light receiving module allows the selection of one of five tuning frequencies, 40.0 kHz, 36.7 kHz, 37.9 kHz, 32.7 kHz, and 56.9 kHz. For reference, FIG. 4 shows a graph of the relative reception distance vs. frequency characteristic of a light receiving module with a tuning frequency of 37.9 kHz.

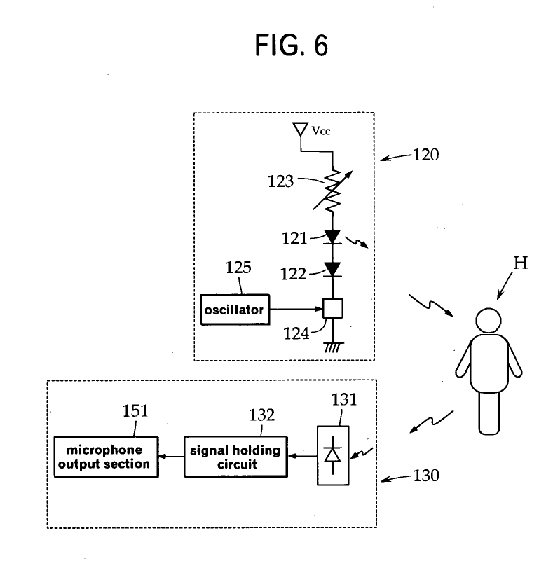

FIG. 6 schematically shows the configuration of circuits of the infrared transmitting section 120 and infrared light receiving section 130. In the infrared transmitting section 120, the two infrared light emitting diodes 121 and 122, together with a semiconductor switch 124 such as an FET, are connected in series between a power source Vcc (in this example, +5.5 V) in the base housing 10 and a ground.

Further, the infrared transmitting section 120 is provided with an oscillator 125 that turns on and off the semiconductor switch 124 at high speed. Accordingly, the infrared light emitting diodes 121 and 122 are lighted at an oscillation frequency of the oscillator 125 to emit infrared rays. The frequency of the infrared light emitting diodes 121 and 122 is equal to the tuning frequency (for example, 37.9 kHz) of the infrared right receiving element 131.

The infrared light receiving section 130 is provided with a signal holding circuit 132 that holds the light reception signals output by the infrared light receiving element 131. The signal holding circuit 132 keeps providing an output on signal to a microphone output section 151 while the infrared light receiving element 131 is outputting a light reception signal. The signal holding circuit 132 provides an output off signal when the light reception signal is discontinued.

Although not shown in detail, the microphone output section 151 is provided on a circuit board 150 arranged in the base housing 10. The microphone output section 151 may be for example, a switch included in an output of a sound signal processing circuit provided and formed on the circuit board 150, the switch being used to turn on and off outputs.

As described above, provided that the infrared light emitting diodes 121 and 122 of the infrared transmitting section 120 are radiating infrared rays at a frequency of for example, 37.9 kHz, if a speaker H stands in a sensing area in front of the microphone as shown in FIG. 6, infrared rays reflected by the speaker H are partly incident on the infrared light receiving element 131.

Thus, the infrared light receiving element 131 outputs a light reception signal to the signal holding circuit 132. The signal holding circuit 132 provides an output on signal to the microphone output section 151. A sound signal from the microphone unit 30 is output to an external receiver (not shown).

In contrast, if the speaker H is not in the sensing area in front of the microphone, no infrared rays having a tuning frequency of 37.9 kHz are incident on the infrared light receiving element 131. Consequently, the infrared light receiving element 131 does not output the light reception signal, with a microphone output remaining off.

If the microphone is installed in a small area and there is a reflector, for example, a wall, near a front surface of the base housing 10, reflected light from the reflector may turn on the microphone output even though the speaker H is not in the sensing area.

To prevent such misdetection, it is preferable to connect for example, a variable resistor 123 between the power source Vcc and the infrared light emitting diode 121 to adjust a diode driving current as shown in FIG. 6. This makes it possible to adjust the intensity of emitted infrared rays in accordance with the area in which the microphone is installed, that is, to adjust the range of the effective sensing area.

The present invention has been described in connection with the goose neck microphone. However, the present invention is applicable to a microphone such as a stand type or a ceiling hanging type which is used at a fixed position.

1. A microphone comprising a microphone unit which converts a sound wave into an electric signal to output the signal from a microphone output section, and a proximity sensor, an output signal from the proximity sensor controllably turning on and off the microphone output section,
wherein the proximity sensor comprises an infrared light receiving element tuned only to a particular frequency to output a light reception signal and an infrared light emitting element which emits infrared rays at the frequency to which the infrared light receiving element is tuned.

2. The microphone according to claim 1, wherein the microphone comprises at least two of the infrared light emitting elements, and the infrared light emitting elements are arranged so that their optical axes are inclined at an angle equal to or smaller than 45° with a center line which faces the front of the speaker.

3. The microphone according to claim 1, further comprising driving current adjusting means for adjusting a driving current supplied to the infrared light emitting elements.
